(19) United States
(12) Patent Application Publication
(10) Pub. No.: US 2022/0411708 A1
(43) Pub. Date: Dec. 29, 2022

(54) PROCESS FOR FORMING A FUEL PELLET

(71) Applicant: CHANGEOVER TECHNOLOGIES LIMITED, Belfast (GB)

(72) Inventors: Kenneth Bristoe FLOCKHART, Belfast (GB); Brian FOX, Belfast (GB)

(21) Appl. No.: 17/756,050

(22) PCT Filed: Nov. 16, 2020
(86) PCT No.: PCT/GB2020/052914

§ 371 Date: May 15, 2022

(30) Foreign Application Priority Data
Nov. 14, 2019 (GB) 1916577.8
Feb. 17, 2020 (CN) 202010095492.2

(51) Int. Cl. C10L 5/36; C10L 5/14

(52) U.S. Cl. CPC C10L 5/363; C10L 5/14; C10L 2250/04; C10L 2290/24

(57) ABSTRACT

The present invention relates to a process for forming a fuel pellet, based on using a particular formula for making the fuel pellets. The process for forming a fuel pellet comprising of the following steps:

providing a particulate carbonaceous material having a particle size of <1 mm;

admixing the particulate carbonaceous material with a polysaccharide or a polyvinyl alcohol binder, and a crosslinker;

shaping the so-formed mixture to provide the fuel pellet.

### FIELD OF THE INVENTION

The present invention relates to a process for forming a fuel pellet, based on using a particular formula for making the fuel pellets.

### BACKGROUND

A continuing problem in many solid-based fuel extraction processes is dealing with waste ‘fine’ materials. As much as 10% of run-of-mine coal can end up as fine (generally about <3 mm) or ultrafine (generally about <0.1 mm) coal dust. This fine coal is often unsuitable for the end process, and, even where the size is not a problem, retains large amounts of water (10%-30%) which can make it “sticky”, difficult to process, and inefficient to handle transport and burn.

One solution has been to form briquettes. These are formed by compressing the fines at very high pressures to physically form a secondary fuel material. However, the high capital and operating costs of briquetting plants have prevented their use beyond some high cost countries. In many places, coal fines are currently simply ‘dumped’ near the coal mine.

Another solution is to agglomerate carbonaceous fines using various processes, including pelletising and extruding. For this, various binder materials have been suggested. In U.S. Pat No. 4,219,519, the major material of the bonding agent is lime or an associated calcium compound. U.S. Pat. No. 3,377,146 lists various organic binders, and U.S. Pat. No. 4,357,145 suggests tall oil pitch. U.S. Pat. No. 4,025,596 describes a method for pelletising finally divided mineral solids using a latex, optionally with bentonite or starches.

However, all of these processes involve the need for some sort of treatment of the pellets after their formation, generally drying at an elevated temperature, so as to provide the final form of the pellets. Thus, all of these processes require some form of heat treatment, usually in line with the use of one or more organic binders. More importantly, all these processes are over 30 years old, and none are known to have been actually used, or used with any success.

Another problem is the weight of moisture. High moisture levels in coal make transportation and combustion inefficient. Sub-bituminous coals, which comprise a large and valuable part of the world's coal reserves, contain “chemically attached” moisture within the coal structure (up to 20%-30% moisture). This “moisture” severely limits the use and value of sub-bituminous coals. For example, for every 3 truckloads of coal that is transported, one truckload of water must also be transported. That moisture also takes (i.e. robs) energy from the flame (to turn the water into steam) as the coal is burnt. Attempts to drive the moisture out by heating have proved unsuccessful because the coal falls apart as it dries, and also becomes susceptible to spontaneous combustion. As a result, very little sub-bituminous coal is traded internationally.

A further problem is using additives which may lead to an increase in the formation of environmentally harmful substances or gases upon burning, in particular sulphur gases such as sulphur dioxide, and various nitrogen gases generally termed ‘NOX’ gases. Hence, it is better to use additives that do not inherently contain S or N heteroatoms.

WO02006/003354A1 and WO02006/003444A1 describe a process for producing fuel pellets based on mixing a particulate carbon-based material and a binder, and agglomerating the mixture by the action of tumbling. The tumbling action serves to agglomerate the particles and bind the mixture into pellets. The agglomeration forms spherical or ovoid shaped pellets, but some time for the migration of the binder to the outside of the pellets is still required to form a ‘hard shell’ to the pellets both to form the pellets, and to provide them with a waterproof shell prior to stacking and transportation.

WO02018/033712A1 describes forming a briquette from a particulate material and a binder comprising at least partially saponified polyvinyl alcohol and an alkali metal alkyl silicon or poly-alkyl silicic acid. However, there is still the limitation that briquettes are confined to use with only large and medium scale boilers due to their size, and still require the use of a briquette press apparatus.

It is an object of the present invention to provide a more efficient process for dealing with such materials, using a suitable pelletisable formula to achieve such process.

### SUMMARY

In one aspect, the present invention provides a process for forming a fuel pellet comprising of the following steps:
providing a particulate carbonaceous material having a particle size of <1 mm;
admixing the particulate carbonaceous material with a polysaccharide or a polyvinyl alcohol binder, and a crosslinker;
shaping the so-formed mixture to provide the fuel pellet.

In another aspect, the present invention provides a fuel pellet formed by a process as described herein.

### BRIEF DESCRIPTION OF THE DRAWINGS

FIG. 1 is a schematic flow diagram of a number of optional pre-steps and a first embodiment of the present invention;

FIG. 2 is a schematic side view of a number of optional pre-steps and a process for forming a fuel pellet according to a second embodiment of the present invention;

FIGS. 3a, 3b and 3c are side views of different parts of FIG. 2; and

FIGS. 4 and 5 are perspective and side views of different sizing apparatus for use in an embodiment of the present invention;

FIGS. 6 and 6a are schematic perspective views of a tumbling agglomerator drum, for use in an embodiment of the present invention, and an enlarged portion thereof;

FIG. 7 is a perspective view of part of a process for forming a fuel pellet according to another embodiment of the present invention; and

FIG. 8 is a diagrammatic view of stoker pellets formed by the present invention.

### DETAILED DESCRIPTION

Fine coal recovery systems are now a common part of modern coal process operations, but there has been a requirement for a cost effective high tonnage solution for utilising the wet coal fines generated by the various beneficiation (benefaction) processes.

High capital and operating costs of briquetting plants have prevented numerous operations from maximising their coal reserves. Briquetting is a process where some type of material is compressed under high pressure. There are low-priced hydraulic briquetting presses which are designed to operate for only a number of hours a day. Bigger mechanical presses used for large-scale installations can operate at hundreds of kilograms per hour, but these require approximately 200 kWh energy input (for drying and processing) per tonne of briquetting material. The cost of this is prohibitive in countries where the cost of coal is already low, such that coal fines are currently simply dumped on nearby ground in many countries around the world.

By way of example only, listed below are various types of mined coal, and their generally found moisture content (m/c) as the coal is mined, their heat content (h/c) and their carbon content.

| | m/c | h/c (mJ/kg) | Carbon |
|---|---|---|---|
| Bituminous Coal | <20% | 24-35 | 45-86% |
| Anthracite coal | <15% | 26-33 | 86-98% |
| Lignite Coal | <45% | 10-20 | 25-35% |
| Sub-bituminous coal | <30% | 20-21 | 35-45% |

The heat content of coal can be directly linked to the moisture content. Therefore, the heat content of high grade anthracite with a moisture content of 15% will have a heat content of 26-33 mJ/kg on a moist mineral-matter free basis. At the other end of the scale, lignite, the lowest rank of coal, will have a moisture content of up to 45%, with a heat content of only 10-20 mJ/kg on a moist, mineral matter free basis.

In most power stations using coal, the coal is generally ground into a fine powder to be sprayed into the combustion furnaces. However, the power for crushing coal having a moisture content of, for example, 25% is relatively high. Thus, it is currently considered that there are currently several million tonnes of ‘unusable coal’ in stockpiles in the US alone. As mentioned above, freshly mined bituminous coal can have a moisture content of up to 20%, lower ranking coal can have a moisture content of up to 30%, with lignite going up to 45%. To drive off this level of moisture (by turning it into steam) prior to any combustion of the actual coal requires so much energy to start with, that this coal is simply not used, as it is not efficient.

In one embodiment of the present invention, there is provided a process for forming a fuel pellet comprising of the following steps:
providing a particulate carbonaceous material having a particle size of <1 mm;
admixing the particulate carbonaceous material with a polysaccharide or a polyvinyl alcohol (PVOH) binder, and a crosslinker;
shaping the so-formed mixture to provide the fuel pellet.

Particulate carbonaceous materials suitable for the present invention can be accepted wet or dry, and could be provided by any type of maceral fuel, including peat and lignite through to sub-bituminous coals, metallurgical coal, anthracite fines, petroleum coke fines and the like, to provide a fuel pellet capable of use in a furnace for direct or indirect heat, heat generation, electricity generation, chemical processes, etc. For example, anthracite fines can be formed into stoker pellets for direct use in a furnace for electricity generation. Metallurgical coal can be formed into pellets for used as a carbon source as well as a fuel source in the industrial reduction of iron-ore to provide iron.

Optionally, the particulate carbonaceous material includes a minority amount (<50 wt %) of another material or materials, including sewerage wastes, biomass, animal wastes and other hydrocarbon materials that could be considered a fuel source. Biomass is generally also carbon based, and includes one or more of the group comprising; wastewater sludge, sewerage sludge, agricultural litter such as chicken litter, bonemeal, spent mushroom compost, wood, wood chippings etc, plant residues including rape seed, hemp seed, corn and sugar residues, and including by-products of industrial processes. These material may already be in a fine or ‘dust’ form, or need grinding to form a particulate material.

The particulate material may also be a combination of two or more starting materials or ‘ingredients’, not necessarily premixed, and such as those hereinbefore mentioned, so as to provide ‘hybrid’ fuel pellets.

It is a particular advantage that the present invention can use any type of ‘wet’ particulate carbon-based feed material, having a water or moisture content of more than 10 wt %, such as in the range 10-50 wt % or higher, including >20 wt % or >25 wt %, or >30 wt % or >35 wt % or >40 wt % or higher. Different locations and countries mine different types and grades of coal, and they therefore use such coals in different ways in order to try and maximise their economic value. The present invention provides a particular advantageous process to benefit what is currently regarded as a waste material from current industrial processes without need for a pre-drying process.

In one embodiment, the feed material, and therefore the particulate carbonaceous material, is coal dust or coal fines. The term “having a particle size <1 mm” as used herein is defined as a particulate carbonaceous material having no more than 10% w/w >1.0 mm, and having no less than 5% w/w <38 μm.

Optionally, the particulate carbonaceous material provided for the present invention has a particle size of <0.5 mm.

Optionally, the feed material for the particulate carbonaceous material is screened before the grinding process, to achieve a more even particle size.

A particle size of a feed material may be generally in the range of >5 mm, and up to 10-15 mm, such as in the range 5-10 mm or 5-8 mm or 6-8 mm.

In one embodiment, the particulate carbonaceous material is provided by grinding a feed material to provide a particulate carbonaceous material having a particle size of <1 mm, with no more than 10%w/w >1 mm and no less than 5% w/w <38 μm (microns).

The grinding provides a particulate carbonaceous material having a particle size of <1 mm, optionally <0.5mm.

The grinding may be provided by one or more of the group comprising: jaw crushers, rotor mills, ball mills, mortar grinders and the like.

Optionally, the grinding is provided as wet grinding.

Optionally, the grinding is provided by a wet grinding mill or by a wet ball crusher. Such grinding may include using an inclined grinder, variable grinding speed, and variations in the number/ratio/sizes of grinding balls, to achieve the desired final size output or grading. Optionally, the moisture content of the feed material during the grinding process is maintained at a pre-determined level such as >20 wt %, including in the range 25-45 wt %, such as in the range 30-40 wt %, by the addition of water if required.

This may requires increasing the moisture content of the feed material prior to grinding by the addition of water. The moisture content may be regularly monitored to help control or otherwise regulate the addition of water to the feed material as it enters a grinder.

Optionally, particulate carbonaceous material for use in the present invention has a water content in the range 18-30 wt %, such as in the range 23-27 wt %.

If required, the material provided by wet grinding, or the ground feed material, is dewatered to provide a particulate carbonaceous material having a water content in the range 18-30 wt %, such as in the range 23-27 wt %.

Dewatering can be provided be any suitable, apparatus, unit or device, or multiples thereof, including but not limited to gravity separators, hydro-cyclones and the like, optionally using one or more sieves or membranes to allow water separation.

In another embodiment of the present invention, the step of providing a particulate carbonaceous material is provided by screening a feed material to provide a particulate carbonaceous material having a particle size of <1 mm, with no more than 10% w/w >1 mm and no less than 5% w/w <38 μm (microns). The screening may include one or more screens working in a coordinated manner or not, and may include one or more vibrating screens. This embodiment may be more efficient or economical where the feed material is already a particulate carbonaceous material sufficiently having a particle size of <1 mm. Monitoring and optionally changing the water content of such a provided particulate carbonaceous material having a particle size of <1 mm may still be desired to provide a suitable material to the next stage of the process of the present invention, in particular to provide a particulate carbonaceous material having a water content in the range 18-30 wt %.

Optionally, a mixture of the provided particulate carbonaceous material and water is buffered to achieve a pre-determined pH, such as being in the pH range 7-10, such as in the range pH 9-10. Buffering can be provided by any suitable buffering reagent or reagents, such as sodium bicarbonate and sodium hydroxide in a manner known in the art.

The provided particulate carbonaceous material is admixed with a polysaccharide or a polyvinyl alcohol (PVOH) binder, and a crosslinker.

Polysaccharides are polymeric carbohydrate molecules composed of long chains of monosaccharide units bound together by glycosidic linkages, which on hydrolysis give the constituent monosaccharides or oligosaccharides. They range in structure from linear to highly branched. Examples include storage polysaccharides such as starch and glycogen, and structural polysaccharides such as cellulose and chitin.

Polyvinyl alcohols are synthetic polymers produced on hydrolysis or partial hydrolysis of polyvinyl acetate and usually characterized by % hydrolysis and molecular weight.

When dissolved in water many polysaccharides and PVOH have the ability to hydrate, trapping water in a hydrocolloid with a large associated increase in viscosity and ‘stickiness’
Optionally, the binder is one or more of the group comprising;
Carboxymethyl Guar
Acacia Gum
Xanthan Gum
Starches and modified starches
Sodium Alginate
Carboxymethyl cellulose
Hydroxyethyl cellulose
Hydroxyethyl methyl cellulose (Tylose)

Optionally, the binder is present in the range 0.1 wt % to 2 wt % based on total dry weight of the particulate carbonaceous material. Optionally, the binder is present in the range 0.2 wt % to 0.7 wt % based on total dry weight of the particulate carbonaceous material.

A number of crosslinkers can be used to crosslink the polysaccharide or PVOH binder. These include a bifunctional reagent able to co-ordinate to two separate polymer chains.

Optionally the bifunctional reagent is a bis-aldehyde, a bis-acid, a carbonate or a borate, containing one or more ions of the group comprising: titanium, sodium, ammonia, zirconium, potassium or calcium.

Optionally, the crosslinker is a zirconium carbonate. Optionally, the crosslinker is sodium borate.

The crosslinker is normally added as an aqueous solution during processing to allow adequate mixing, as the amount added is very small in relation to the overall mix.

In one embodiment, the crosslinker and binder have a weight ratio with the dry weight of the particulate carbonaceous material (i.e. less any moisture content of the particulate carbonaceous material) in the range 1 g to 1 kg, such as in the ranges encompassing 1.5 g, 2 g, 2.5 g, 3 g, 3.5 g, 4 g, 4.5 g, 5 g, 5.5 g, 6g, 7g, 8g, 9g, or 10 g per 1 kg of the dry weight of the particulate carbonaceous material.

The dry weight of the particulate carbonaceous material can be easily calculated by taking a measurement of the moisture content of the feed material for the particulate carbonaceous material in a manner known in the art, and subtracting the calculated weight of the measured water content.

In one embodiment, the binder is present in the range 0.1 wt % to 2 wt % on dry weight, (i.e. less any moisture content of the particulate carbonaceous material), such as in the range 0.2 wt%, 0.3 wt %, 0.4 wt % or 0.5 wt %, to 0.6 wt %, 0.7 wt %, 0.8 wt %, 0.9 wt %, 1 wt % or 1.5 wt %.

In another embodiment, the crosslinker is present in the range in the range 0.00001-0.001% w/w on dry weight of the particulate carbonaceous material, (i.e. less any moisture content of the particulate carbonaceous material).

The present invention is not affected by high ash content or sulphur content in the particulate material.

In addition, the binder and crosslinker useable in the present invention do not include any S or N heteroatoms, and so do not add to the sulphur or nitrogen content of the particulate carbonaceous material in any way, such that the present invention does not add to the emission of any further sulphur or nitrogen based gases upon burning of the formed pellets. That is, the pelletisable formula of the present invention provides a ‘neutral’ effect, allowing the immediate use of pellets formed by the formula of the present invention in existing power stations or industrial locations or other furnaces using, for example, a coal or carbon-based source material.

This is particularly suitable in the case of the process of the present invention forming pellets for use as metallurgical coal or ‘metcoal’, a grade of coal that is used in industry to produce good quality coke. Coke is an essential fuel and reactant in the blast furnace process for primary steel making, partly for fuelling the coking process, but equally important as being the primary reducing agent for removal of the oxygen from the base iron ore (as carbon dioxide). The process of the present invention allows the pellets formed to be immediately useable as metcoal, because the formula is neutral in relation to adding any additional components that could otherwise introduce deleterious compounds. Some known pellet formulae have components that include one or more sulphur or nitrogen atoms or sulphur- or nitrogen-based compounds. The present invention avoids any such components or compounds, and therefore allows pellets formed by the process to be immediately useable with other metcoal in a manner known in the art.

In one embodiment of the present invention, there is provided a process using a pelletisable formula consisting of, or consisting essentially of, a particulate carbonaceous material being coal dust or coal fines, a polysaccharide binder, and a crosslinker being zirconium carbonate or sodium borate.

According to another embodiment of the present invention, the process uses a pelletisable formula that includes an ingredient able to reduce the emission of a sulphur based gas, or of a nitrogen based gas, or both such gases, upon burning of the formed pellets. Such gases include sulphur dioxide and one or more of the ‘NOX’ gases such as NO2 or NO3.

For example, the addition of a powdered carbonate such as calcium carbonate, into a pelletisable formula, allows the carbonate to be intimately mixed and distributed throughout the so-formed pellets, and so to react with any sulphur dioxide formed during the burning of the so-formed pellets, to form calcium sulphate, avoiding the emission of the sulphur dioxide into the atmosphere. Such sulphur dioxide is not created by the process of the present invention, but is formed from one or more sulphur compounds either in the particulate carbonaceous material, or other material being burned alongside the pellets formed by the present invention.

In this way, the present invention further provides a method of reducing the emission of a sulphur based gas, or of a nitrogen based gas, or of both such gases, upon burning of a fuel material including one or more S or N heteroatoms, or both, comprising the step of adding to the material pellets formed by a process as defined herein, said process using a pelletisible formula including an ingredient able to react in use with S or N heteroatoms in the material, or with a sulphur based gas, or with a nitrogen based gas, or with both such gases, to form a solid residual material.

Optionally, the added ingredient is a powdered carbonate such as calcium carbonate, magnesium carbonate or mixtures thereof such as obtained from crushed limestone or dolomite.

Optionally, the fuel material is a maceral fuel, including coal.

Another suitable feed material for the present invention is silica metal coal. Silica metal coals can form a suitable particulate carbonaceous material. Optionally, the process of the present invention is carried out at ambient or near-ambient temperature. Ambient temperature is a term known in the art, and includes a near-ambient temperature. Ambient temperature can range from −10° C. to 40° C., depending on the location of the process, and local conditions.

Optionally, the process is able to form rigid fuel pellets from a particulate carbonaceous material.

Admixing of the particulate carbonaceous material, polysaccharide or polyvinyl alcohol binder, and the crosslinker provides a pelletisable formula able to form fuel pellets according to the present invention.

Optionally, the admixing of the particulate carbonaceous material, polysaccharide or polyvinyl alcohol binder, and the crosslinker, involves pre-blending, kneading in a mixer, or both.

Pre-blending the components, optionally in a dedicated pre-blender, achieves accurate dosing of the components.

Optionally, the admixing of the particulate carbonaceous material, polysaccharide or polyvinyl alcohol binder, and the crosslinker to form the pelletisable formula forms a slurry. Optionally, the slurry has an increased density compared with the provided particulate carbonaceous material, especially if water is added in comparison to the particulate starting material (for example coal fines).

Optionally, the density of the so-formed slurry is greater than 0.5 g/ml.

Optionally, the slurry forms a paste.

Optionally, the blended particulate carbonaceous material, polysaccharide or polyvinyl alcohol binder, and crosslinker is then further admixed. Such further admixing includes active working or mixing, such as kneading, pounding, shearing, pummelling, twisting or other types of active blending, generally involving arms or paddles or wheels or the like, to achieve a more consistent material.

Optionally, the further admixing is carried out in a separate mixer involving mixer wheels rotating within a mixer vessel, able to knead and shear the content of the mixer vessel, such as a muller-mixer but not limited thereto. Other densifying mixers are known, including but not limited to having multiple mixing wheels, generally two mixing wheels, able to travel wholly or substantially horizontally to mix, knead and shear the contents together into a wholly or substantially homogeneous mixture for subsequent processing.

During the pre-blending, or the kneading, or during both, the moisture content of the mixture can be monitored, and additional moisture can be added if required to achieve a pelletisable material.

Optionally, the further admixing allows the coming together of particles, expulsion of trapped air, and increases the density of the so-formed material, such as increasing the density to >1 g/ml.

In one example of the present invention, the density of the so-formed mixture is in the range 400-600 kg/m3, such as 550 kg/m3.

Optionally, the shaping comprises an agglomeration step. The agglomeration step includes tumbling agglomeration, or extrusion, or both. Extrusion includes hot extrusion, cold extrusion, warm extrusion, micro-extrusion, vacuum extrusion, plastic extrusion, friction extrusion, et al.

Tumbling agglomeration includes the use of one or more drums, optionally horizontal or at a small incline to horizontal, through which the so-formed mixture passes, and through rotation of the drum(s) causes agglomeration of the mixture during the passage of the material along the length of the drum.

Optionally, the tumbling agglomeration includes using a drum having a variable size along its length from an input end to an output end. This may include the use of one or more inserts or ribs, generally longitudinal inserts and rubs. Optionally, one or more of any inserts or ribs may extend inwardly from an internal circumference of the drum. Such inserts or ribs may be variable in height to allow adjustment in their extension or depth from the internal circumference of the drum. Optionally, the drum also includes an inner pelletiser lining around its internal circumference, and one or more of any inserts or ribs could be used to cause variation in the internal circumference of inner pelletiser lining.

Optionally, the shaping in the process of the present invention further comprises includes a post-mixing pre-agglomeration sizing step, to size the now thoroughly mixed particulate carbonaceous material, polysaccharide or polyvinyl alcohol binder, and crosslinker components.

Sizing involves determining the post-mixing or outflow of the so-formed material from the mixing, to become a more regular flow, and optionally a more regularly shaped flow.

Optionally, sizing involves determining at least one dimension of the so-formed material through a flow regulating means such as a gate or die or screen, or multiple thereof.

Optionally, the sizing includes shaping the so-formed material into a regular shape or multiple of shapes, prior to entry of the material into the pelletising stage.

The sizing can be determined using suitable sizing apparatus, devices or means, including suitable hoppers, extruders, screens, vibrators and dies. Optionally the sizing also includes a conveyor, to convey the outflow of the so-formed material to the pelletising stage.

In one embodiment of the present invention, the sizing comprises the use of a gated hopper.

A gated hopper generally comprises a hopper having a gate on one side, generally at or near the bottom of the hopper, able to provide a dimensioned aperture. One or more dimensions of the aperture can be changed by movement of the gate from a closed position to one or more open positions. Variants of movement of the gate allow a user to vary the size of the aperture, and thereby vary the size of material flowing therethrough; typically varying the height or depth of material. A gated hopper allows the collection of the post-mixed material under the mixer or mixers admixing the components, and to provide a regular flow of material based on a determined height or depth to a conveyor such as a conveyor belt extending beyond the gate. Optionally, the conveyor directly feeds the sized material into the next step or stage of the shaping of the so formed mixture, in order to provide the fuel pellets of the present invention.

Optionally, any conveyor may include one or more regular dividers, arms or knives to divide the conveyed material into determined lengths, being regular or not regular.

In another embodiment to the present invention, the sizing comprises the use of an extrusion hopper. An extrusion hopper generally comprises a hopper entrance for the receipt of post-mixed material from the admixing, and an extruder at or near a lower portion of the hopper, having a die or dies or screen or screens on one side, and a complementary and opposing extrusion face or plate. The extrusion plate may be operated and controlled by an actuator, typically a hydraulic ram and piston arrangement, to push material collected in the hopper through the die or dies etc., to provide sized material for the shaping step or stage.

The outlet of the extrusion hopper may coincide with a suitable conveyor, able to convey the outflow of the extrusion hopper to the pelletisation stage.

Optionally, the sized material is wholly or substantially regular. Alternatively, the shaped material comprises more than one size, so as to provide more than one size of material for shaping, and expectantly more than one size of formed fuel pellet. The skilled man is aware that a gate or die can be formed with regular or different shaped apertures to provide the same or a variety of shaped material therethrough, and that the egress of material through a die typically results in fracturing of the material along the length of extruded material, to form broken portions of material.

The size and shape of the pellets being formed can be adjusted based on the process conditions for shaping, such as one or more of the group comprising: pelletiser-drum size, inclination of the pelletiser, rotation speed, moisture content, impact force, impact height and residence time.

Optionally, the shaping in the present invention includes a post-pellet forming screening step.

Optionally, the screening step uses a multiscreen hopper having a pre-determined maximum pellet size screen, a predetermined minimum pellet size screen, or both. An example of a multiscreen hopper is a grizzly hopper, optionally a vibrating grizzly hopper. Another example is a multi-deck screen unit, having a deck of different sized screens or meshes, and to use gravity, and optionally vibration, to screen the pellets into different sizes or mesh sizes. Such screening can be to divide the agglomeration products into at least an oversize portion, an underscreen portion, and a desired portion.

Optionally, one or more of any screens or screen decks are formed with fast flow mesh, generally being welded mesh.

The pelleted material can be screened after pelletising to produce a desired, typically narrower, size distribution. The screening can be provided by any suitable screening unit, device or apparatus, to provide a size distribution optionally in the ranges encompassing a lower diameter of 2 mm, 3 mm, 4 mm, 5 mm, 6 mm, 7 mm, 8 mm, 9 mm, 10 mm or higher, and an upper diameter of 25 mm, 28 mm, 30 mm, 32 mm, 35 mm, 37 mm, 40 mm or higher.

One suitable pellet range is 6-32 mm. Such a range is in line with known stoker coal. Stoker coal is typically formed in a range of well-known sizes termed ‘¼″’ (quarter inch), ‘½″’ (half inch), ‘¾″’ (three-quarter inch), ‘1″’ (1 inch) and 1, ¼″’(one and a quarter inch). The present invention is able to form stoker pellets matching these sizes, and so assisting their use alongside i.e. mixed with, the stoker coal in a conventional furnace.

Optionally, the process of the present invention includes recycling at least a portion of the formed fuel pellets.

Optionally, where the shaping includes a post-pellet forming screening step, the process of the present invention further comprises recycling a portion of the formed fuel pellets screened out by the screening step.

Optionally, the selection of portion or portions of the pellets is carried out by as an integrated multi-deck sizing screening step. This could be carried out by a multi-deck screen unit, having a deck of different sized screens or meshes, and to use gravity, and optionally vibration, to screen the pellets into different sizes or mesh sizes, and returning, by one or more conveyors, pellets of an undesired size, typically undersize or oversize, back into the agglomeration step.

The recycling can improve the efficiency of the process of the present invention, by reducing the amount of any pellets not matching the requirements of the operator. The recycled material can be added back into the shaping at any suitable stage, such as being re-worked or re-kneaded, or added back to be re-sized, or added straight back into the pelletizing, such as the input end of the drum of a tumbling agglomerator.

As with any process, the skilled person can see that adjustments to one or more of the process conditions or parameters of any of the stages or steps of the process of the present invention described herein, allows the user to control and refine the output of the shaping stage, so as to maximise the size or shape of the pellets formed, and/or minimise screened material not matching the required size or shape. As with every process, it is desired to optimise the process conditions, operating conditions and parameters etc., and the skilled person can directly see the outcome of any such changes by the nature of the pellets formed, and/or the amount of recycled material.

In one example of the present invention, the density of the so-formed pellets is >1000 kgm3, such as 1200 kg/m3.

Optionally, the process of the present invention further comprises the step of stockpiling the formed fuel pellet under cover for 1-7 days. This assists the cold curing and hardening of the pellet.

The initial pellets may have a green strength of about 20 pounds-force, such as above 80 N to 89 N or 90 N or more.

Optionally, the stockpiling is at least initially carried out under cover, i.e. under a protective screen or roof or ceiling, to prevent direct atmospheric conditions such as rain falling on the pellets. Following any initial curing, the formed pellets are optionally rested for some time, possibly a number of days such as 1-7 or 3-7 days, to provide or allow for curing to finish. Like other curing products, the pellets continue to cure to gain strength over time, such as a further number of days or weeks.

Optionally, the process includes at least the steps of:

providing a particulate carbonaceous material having a particle size <1 mm or <0.5 mm and a water content in the range 18-30 wt%;

mixing the so-formed material with the binder and a crosslinker in a pre-blender to form a pellet formula;

kneading the pellet material in a mixer to form a mixed material; sizing the mixed material;

pelletising the so-formed material to form pellets;

screening and sizing the pellets;

recycling pellets rejected by the screening and sizing back into the agglomeration; and

stockpiling the pellets under cover for 1-7 days.

The size of the pelleted material being formed can be adjusted based on the process conditions for shaping, such as one or more of the group comprising: the sizing conditions and parameters, the pelletiser-drum size and internal configuration, inclination of the pelletiser, rotation speed, moisture content, impact force, impact height, and residence time, and post- forming screen sizes.

The present invention also provides a fuel pellet prepared by a process as defined herein, preferably at ambient temperature, and optionally formed from a coal dust or coal fines.

The fuel pellet product of the present invention is a material which is easily storable. It is also easily transportable due to its variable diameter distribution. This enhances stacking concentration, which also reduces abrasion and consequential breakage of the pellets.

More preferably, the pellets have sufficient hardness once formed to allow handling, stacking and/or transportation without any significant breakage.

It is a particular advantage of the present application to form pellets by shaping rather than briquettes. It is a particular advantage of the present invention that pellets can be formed having a smaller size than previously suggested in the art, i.e. with a greater relative surface area making them easier to burn and faster to transfer heat, than briquettes.

Optionally, the pellets are any suitable shape or design, including spherical but not limited thereto, as well as a variety of sizes.

Such pellets can be formed to be the same as or similar to the dimensions of ‘stoker’ coal, for their direct use in the same locations as conventional stoker coals used.

In another embodiment of the present invention, the process of the present invention is carried out by modular apparatus and/or mobile apparatus, able to be relocated to a new location for use with different sources of particulate carbonaceous material.

Optionally, a number of, optionally all, of the processing devices, units or apparatus useable with the present invention are modular and/or mobile, to allow a user to relocate such devices, units or apparatus. For example, the processing devices, units or apparatus useable with the present invention are mounted on or moveable by road trailers or are in road containers.

Embodiments of the present invention will now be described by way of example only and with reference to the accompanying drawings.

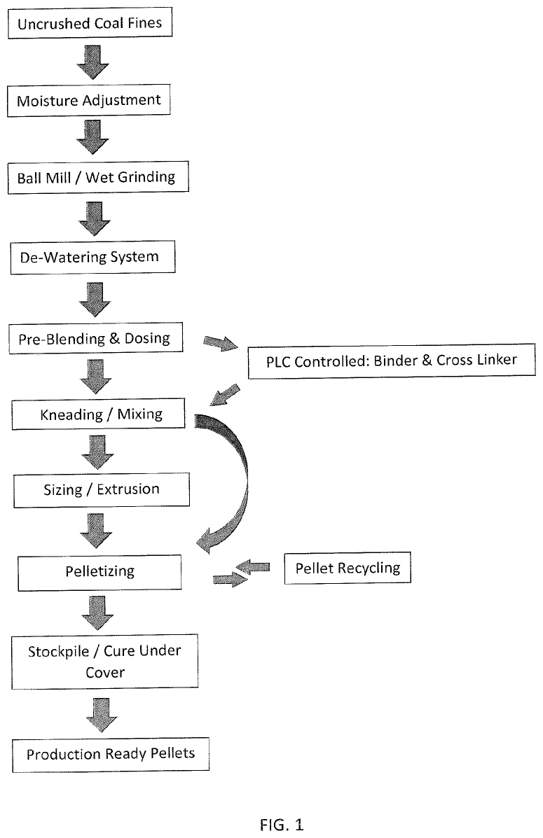

FIG. 1 shows a schematic flow diagram for a number of process steps, including steps of a process for producing a fuel pellet at ambient temperature as defined herein.

The first step of the present invention is in providing a suitable particulate carbonaceous material having a particle size of <1 mm, optionally <0.5 mm. Such particulate carbonaceous materials can be provided by various processes, or be provided directly as a feed material where available.

FIG. 1 starts with steps to provide an example of a feed material from uncrushed coal fines. A suitable feed material are ‘raw coal fines’ as described herein, which may be provided from one or more stock piles of coal fines which are typical at coal producing or coal storing locations.

Preferably, such a feed material is pre-screened to achieve a more regular size, preferably such as in the range of 5-8 mm diameter, although the invention is not limited thereto.

Such a feed material may have any suitable moisture content, and moisture contents (by weight) of more than 5% such as in the range 10-20% or higher are known in the art. The present invention is not limited by the moisture content of the feed material.

Such a feed material can undergo milling. The milling can be provided by any suitable grinder or grinding apparatus, for example a grinding mill or a ball crusher.

Depending on the type of milling, and other process parameters, there can be adjustment of the water content of the feed material. Typically, the moisture content of the feed material is monitored using a suitable sensor, and a water feed from an adjustable valve or tap is adjusted to provide the desired grinding moisture content.

The feed to the milling may be carried out as a continuous process or as a batch process, and is preferably based on having a moisture content of at least 20 wt %, optionally at least 30 wt % or 40 wt %. The moisture content can be measured using any suitable apparatus or sensor such as a moisture analyser, and suitable additional water can be added to maintain the pre-determined moisture content level. A higher moisture content not only aids the grinding process, but also helps to prevent any ignition of the carbonaceous material as it is being crushed.

The milling of the feed material can be adjusted based on one or more of the speed of the mill or grinder, any inclination, and the amount and/or size of any crush material such as ball bearings, in a manner known in the art.

The milling achieves a particle size <1 mm to make it suitable as a particulate carbonaceous material for use with the present invention. Particle size can be easily measured by suitable apparatus, such as by sieve analysis or Dynamic Image Analysis (DIA), to determine its achievement.

Optionally, such a feed material can be passed to a suitable location or tank such as a pulp settlement tank, to allow some settlement of the particulate carbonaceous material, which can then be extracted from a suitable lower or bottom location, to undergo a de-watering process.

The de-watering stage is intended to reduce the moisture content of a wet milled feed material to a lower level, such as in the range 18-30%, such as being 23-27% (all by weight). The de-watering can be provided by any suitable apparatus, means or mechanism, being active or passive or a combination of same, including one or more membranes, screens or driers or hydrocyclones, etc.

The particulate carbonaceous material provided as described above or from another route or source, passes to an admixing stage of the present invention, for combining with the binder and cross-linker. The admixing may be carried in a single step, or in a combination to steps or stages.

Optionally, the particulate carbonaceous material, binder and cross-linker are initially blended to form a pellet formula or a pelletisible formula. The pre-mixing may be carried out under controlled conditions, based on pre-weight batch control and regulated dosing flows from supplies of the binder and cross-linker.

Accurate dosing can be achieved by in a controlled environment using a pre-blender known in the art, and processing control of the dosing of each component.

Further mixing, typically more active mixing, of the components, can then be provided as a second stage. Such mixing can include kneading, pounding, pummelling, twisting or other types of active blending, generally involving arms or paddles or wheels or the like, to achieve a more consistent material.

The further mixing can be provided by a suitable mixer or mixing machinery. In one embodiment, the further mixing is provided by a kneading mixer, an example of which is a muller mixer. Kneading mixers are known in the art, typically comprising internal wheels, often arranged in an opposing or twin set-up, which travel within a pan, frame or bowl. The mixing wheels may be adjustable in height from the floor level, and include spring lock or rocker arms to help spread the material. The motor speed may be in the range 5-65 RPM, and the mixer may also include scrapers, optionally at different levels or heights within the pan, to ensure removal of the mixed material at the end of the mixing.

Optionally, the pre-mixed pelletisible material is provided into the mixing by suitable injectors, such as high pressure or pneumatic injectors, intended to provide a forced or high pressure blast directly into the mixing pan over a pre-determined time period, so as to avoid the rocker arms of the mixture moving the wheels, and to maximise the blending of the mixture to form a homogeneous final material. Optionally, the mixing includes the use of one or more motion sensors to accurately determine the placing of the binder and cross-linker into the pre-blender and/or mixing pan.

During the pre-blending, or the kneading, or during both, the moisture content of the mixture can be monitored, and additional moisture can be added if required to achieve a pelletisable material.

Optionally, the mixing also increases the density of the final material to >1 g/ml.

Once the mixing has been achieved, which can be determined by a suitable apparatus or sensors, the so-formed material undergoes shaping. Optionally, the first shaping is sizing.

In one embodiment, the so-formed material from the mixing is passed into a hopper, having an adjustable exit gate through which the material passes. The positioning of the gate determines the size of the material prior to pelletising. One suitable gate is a bell cast chute door.

Optionally, the exit of the sizing stage includes a conveyor mechanism, such as a conveyor belt, along which the sized material can be provided to feed the sized material towards a suitable pelletiser.

The sized material may be in the form of logs, i.e. cylindrical shapes, whose shape can be developed, e.g. to a more spherical shape during the shaping stage.

The next part of shaping may be a pelletising stage, able to be provided by a suitable rotary drum or drums, wherein the sized material from the sizing stage is dropped. Optionally, the internal surface of the drum or drums includes one or more ribs. The ribs assist holding material against the internal surface of the drum as it rotates from a bottom position and travels upwardly. Optionally the ribs are adjustable in their extension or height from the general internal diameter of the internal surface of the drum or drums, so as to vary the internal surface of the drum or drums, and the action of the ribs.

Optionally, the drum or drums are adjustable in relation of the speed, such as in the range 5-60 RPM, and adjustable in terms of inclination or pitch, such as being +/−2.5° along its horizontal axis.

Rotary drums have low capital and low operating costs, especially in comparison with briquetting plants. They can even be provided in mobile form, such that the process of the present invention can be provided where desired or necessary, e.g. moved and located to where a particulate material is currently stored or ‘dumped’, rather than requiring significant movement (and therefore cost) for transporting the material to a fixed processing site.

The tumbling action in the rotary drum serves to agglomerate the particles and bind the mixture into the pellets, usually with a variable size distribution. No mechanical compression force is required, (with its attendant low production rate and high cost), and the processes of the present invention can be carried out at ambient or near-ambient temperature.

Preferably, the processes provide pellets having a hardened outer portion, skin, casing or shell. More preferably, the interior of the pellets is dry, and wholly or substantially in an internal dust-like, particulate and/or powderous form. One way of achieving this is to allow the formed pellets to dry at ambient temperatures and under cover for 1-7 days, following which the pellets have sufficient green strength to allow their further stacking and/or stockpiling, in particular into larger piles, and without requiring cover, which are in time ‘production ready’ pellets.

Optionally, the agglomerated pellets formed by the present invention are rested or tumbled more gently for a short period, generally a number of minutes, prior to undergoing a curing and/or polishing step. This curing and/or polishing step could be provided by further tumbling action, for instance in the same or another rotary drum.

Optionally, there is part or full recycling of pellets and/or material that emerges from the agglomeration action that is not pelleted as expected, desired or correct, in particular being the correct size, shape, etc. For example, some pellets could be either greater than a maximum desired size or less than a minimum desired size. Such pellets and/or material can be recycled back for further agglomeration and pelletizing via one or more conveyors. Optionally, such pellets and/or material may also be also processed, such as breaking up or mincing, to assist the recycling.

Following initial curing, the formed pellets are preferably allowed to be rested for some time, possibly a number of days such as 3-7 days, to provide or allow for any final curing. Like other curing products, the pellets continue to cure to gain strength over time, such as a further number of days or weeks.

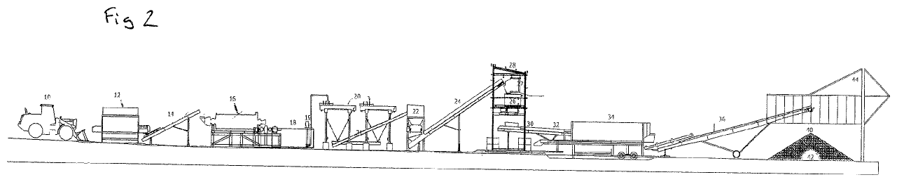

FIG. 2 shows a side view of apparatus for performing a number of optional pre-steps and then a number of steps for a process for forming a fuel pellet according to a second embodiment of the present invention. FIG. 2 shows, starting from the left hand side, an industrial loader or loading shovel 10 able to load a loading or weigh feed hopper 12 with a suitable feed material as discussed herein. The loading hopper 12 provides a regulated or regular feed to a first batch feed conveyor 14, able to provide a feed into a ball mill 16.

The output from the ball mill 16 falls into a suitable holding or settlement tank 18, from which material can be pumped by a pump 19 into one or more thickening screens 20. The material passing through the thickening screens 20 can be collected by a suitable second or de-watering conveyor 21, held in a suitable buffering storage or hopper 22 ready for use in the present invention. The material in the hopper 22 is particulate carbonaceous material. From the hopper 22, the material can then be dropped when ready onto a mixer feed inclined screw auger 24, having an outlet above a pre-blender 27 and a kneading mixer 26, both in and on a suitable structural platform 28.

The preblender 27 provides blending and dosing control, and can include a microbatcher able to provide an even flow of binder and crosslinker into the material as it traverses down into the mixer 26. This helps preventing clumping of the binder as it comes into contact with the wet material. A microbatcher can also assists achieving a faster homogeneous mix.

The pre-blender 27 provide initial mixing of the particulate carbonaceous material, the binder and the crosslinker, under controlled conditions, prior to more active mixing of the components in a mixer 26 in a continuous or batch process. The mixer 26 has an outlet able to pass material downwardly to a sizer 30 discussed hereinafter in more detail, and along a pelletiser feed conveyor 32 and into a pelletizer unit 34, based on a rotating drum, the outlet from which provides material to the lower end of an incline stacking radial conveyor 36. The outlet end of the incline stacking radial conveyor 36 provides a stockpile 40 of pelletised coal fine spheres or formed fuel pellets, optionally formed over a void curing air chamber 42 or similar, like vented pedestals, able to provide a draft of air internally to the stockpile 40, and having a curing cover 44 to provide elemental shelter for at least 1-7 days, typically 3-7 days.

Parts of the process shown in FIG. 2 are now described in more detail.

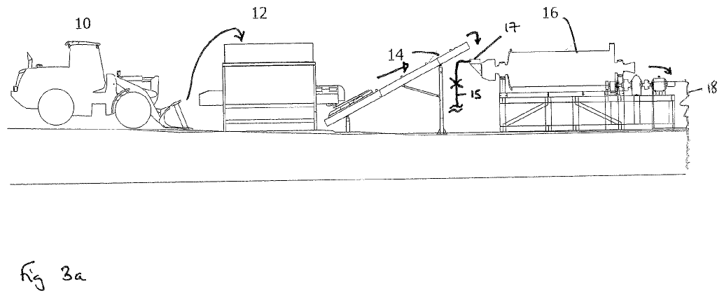

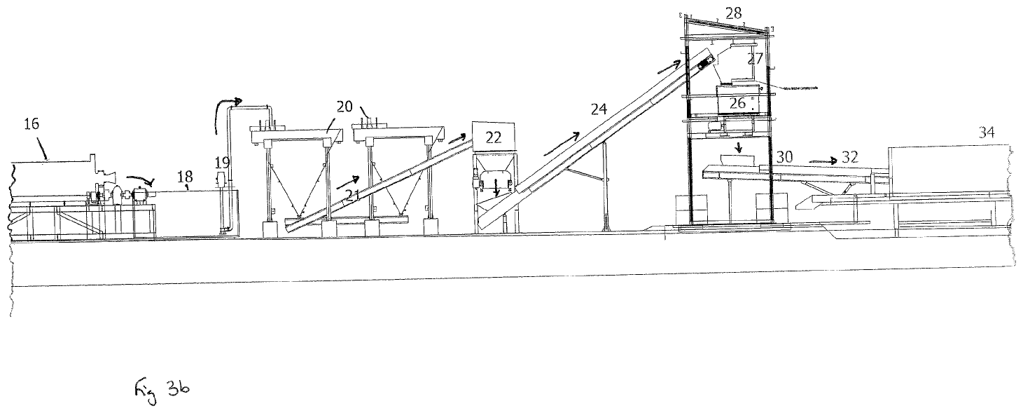

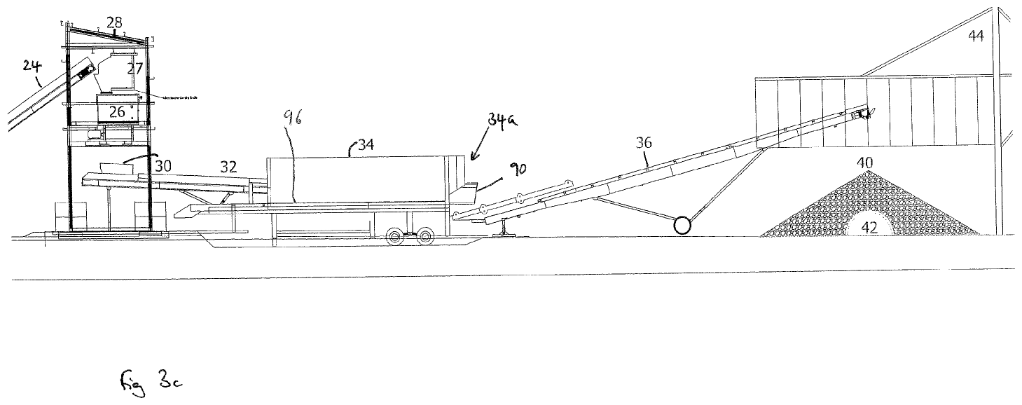

FIG. 3a shows an enlarged portion of the initial parts of the process of FIG. 2, in particular the hopper 12 feeding the loading conveyor 14 into a suitable ball mill 16. The outlet of the feed hopper 12 can be controlled to provide a regulated and/or periodical outflow of material, so as to regulate or regularize material passing into the ball mill 16.

The ball mill 16 is a wet grinding ball mill, able to regularize the particle size of the feed material provided into the hopper 12 and along the first conveyor 14, to provide a particulate carbonaceous material having a particle size of <1 mm or even <0.5 mm.

The inlet to the ball mill 16 includes a moisture analyser 17 able to determine the moisture content of the feed material, and increase the moisture content when required by the addition of water from a water source 15.

Typically, the ball mill 16 is able to grind the feed material to provide a particulate carbonaceous material having a particle size of no more than 10% w/w >1 mm, and no less than 5% w/w<38 μm (microns).

In one option, the outflow of the ball mill 16 is screened, in order to achieve wholly having a particle size <1 mm. The skilled person is able to sample the outflow of the ball mill 16, and determine its graded particle sizing based on the known combination of graded sieves or screens, which can identify the grading or graduation of the particle size from the largest mesh size through to the smallest mesh size used. In this way, the skilled person can determine the operating parameters of the ball mill 16 in order to achieve a grading of the particulate carbonaceous material provided from the ball mill as desired for the process of the present invention.

Moving from FIG. 3a to FIG. 3b, the outlet from the ball mill 16 is provided into a suitable holding tank 18, which allows some settlement of heavier material of the outlet flow material, such as the intended particulate carbonaceous material. The holding tank 18 can have an inclined floor to assist collection of material towards the bottom of a pump 19. The pump 19 provides material from the bottom of the holding tank 18 into one or more thickening screens 20. The thickening screens 20 provide de-watering of the material in the holding tank 18, in particular to reduce the moisture content of the particulate carbonaceous material to between 18-30 wt %. That is, it is desired to have a reduced moisture content material for the next stage of the process of the present invention, compared to the moisture content of the feed material being ground in the ball mill 16.

The screened material provided by the thickening screens 20 through suitable bottom outlets passes along a suitable conveyor 21 in FIG. 3, to a buffer storage hopper 22, to help regulate the production rate thereafter. Optionally, the material in the hopper 22 is occasionally or regularly agitated to break up any surface covering, such as ice (where the ambient temperature is relatively low, such as below ‘freezing’, and/or the material is stationary for a period of time before proceeding further. Agitating the material assists monitoring the moisture content by a suitable sensor, and reducing the chance of false or erroneous readings.

FIG. 3b shows the hopper material 22 being fed onto the bottom of a feed inclined screw auger 24 in order to travel above and be presented towards a pre-blender 27, and then to a lower mixer 26 and associated apparatus, supported by a platform 28.

The pre-blender 27 is able to admix the particulate carbonaceous material, the binder and the crosslinker materials under controlled conditions, to form a pelletisible formula, prior to entry into the mixer 26.

The mixer 26 can blend and knead material fed thereinto, generally using an internal twin wheel set-up, which is adjustable. A suitable speed for the twin wheels may be in the range 10-50 rpm, optionally being variable according to process parameters such as the weight or the length of time of material poured thereinto, and/or the intended mixing time. Optionally, the mixer 26 is programmed to operate based on parameters of the feed material provided by the buffer hopper 22, and intended amounts of binder and crosslinker to be added, to provide a suitable formed material, which then passes onto the bottom of a sizer 30.

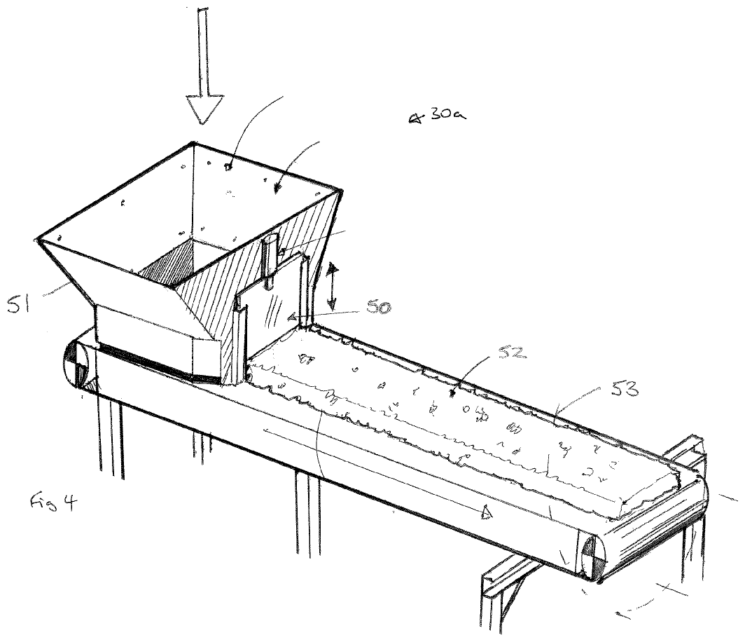

FIG. 4 shows one example of a sizer being a gated hopper 30a. The gated hopper 30a comprises a hopper entrance 51 having an adjustable gate 50 on one side, generally at or near the bottom of the hopper 30a, able to provide a dimensioned aperture. One or more dimensions of the aperture can be changed by movement of the gate 50 from a closed position to one or more open positions. Variants of movement of the gate allow a user to vary the size of the aperture, and thereby vary the size of material flowing therethrough; typically varying the height or depth of material. A gated hopper provides a regular flow of material 52 based on a determined height or depth to a conveyor belt 53 extending beyond the gate 50.

In particular, the adjustable gate 50 creates an outlet size, wherein at least the height of the outlet is adjustable to a height suitable for the expected conditions and parameters of the pelletizer drum 34. In one embodiment, the height of the gate 50 above the conveyor belt is in the range 30-35 mm. The outlet material 52 passes along a conveyor 53 towards a pelletiser drum 34 discussed hereinafter.

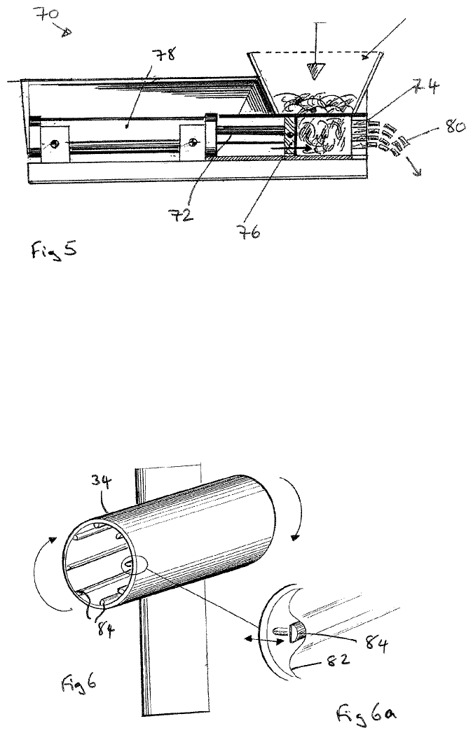

FIG. 5 shows an alternative example of a sizer being an extrusion hopper 70.

The extrusion hopper 70 comprises a hopper for the receipt of post-mixed material from the admixing, and an extruder 72 at or near a lower portion of the hopper, having a die 74 on one side, and a complementary and opposing extrusion plate 76. The extrusion plate 76 is operated and controlled by a hydraulic actuator 78, to push material collected in the hopper through the die or dies etc., to provide sized material 80 for the shaping step or stage.

The outlet of the extrusion hopper may coincide with a suitable conveyor (such as conveyor 32), able to convey the outflow of the extrusion hopper to the pelletisation stage.

FIG. 6 shows a diagrammatic drawing of a pelletizer drum 34, generally having an elongate shape, and optionally with a flexible internal surface 82 and a number of internal ribs 84, shown in more detail in the enlarged portion FIG. 6a. The ribs 84 can be flush with the internal circumference of the pelletizer drum 34, and optionally are extendable into the interior of pelletizer drum 34, so as to form a series of extendable ribs along the longitudinal inner surface of the pelletizer drum 34, such that the internal surface 82 has increased variation (in a cross-sectional view). The ribs 84 help to vary the height of the crests of the internal surface 82, which then increases the amount of pellet material able to be carried by the inserts from the bottom of the pelletizer drum 32 as it rotates, to a higher position, prior to its falling downwardly back to the bottom of the pelletizer drum.

This is the standard motion of the material in a pelletizing drum, but variation of the height of the ribs 84 assists variation of the pelletizing action, and provides variation in the output, in particular the size distribution of the pellets and/or the size ratio of the pellets so formed. Variable ribs 84 provide the user with a further process parameter able to be controlled and refined, to provide the desired output at the end of the pelletizer drum 34.

FIG. 3c shows the output end 34a of the pelletizer drum 34, at which is located a first grizzly hopper 90 able to size the material in a manner which helps regularise the material to either a maximum pre-determined size, or to a minimum pre-determined size, or both.

FIG. 3c also shows the radial stacking conveyor 36 able to accept the fuel pellets approved by the grizzly hopper 90, for stockpiling as shown in FIG. 2.

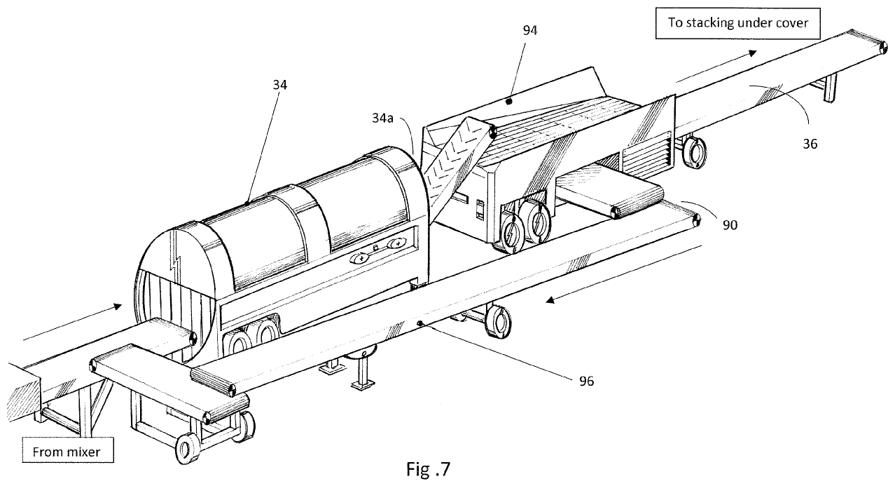

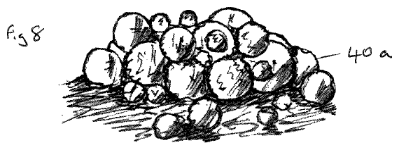

FIG. 7 shows an alternative grizzly hopper 90 at the output end 34a of the pelletizer drum 34. The grizzly hopper 90 comprises a top screen 94 able to screen pellets formed of a greater than desired pre-determined size, and one or more internal screens or meshes, able to screen downwardly pellets or pellet material that are smaller than a pre-determined minimum size. Suitably sized pellets passes onto the radial stacking conveyor 36 for stockpiling as shown in FIG. 2.

FIG. 8 shows a diagrammatic drawing of a range of fuel pellets 40a formed by the present invention, being stoker pellets having a diameter generally being in the range between ¼inch (generally 6 mm), up to 1.¼ inch (generally 32 mm).

Such material that is either greater than a maximum or less than a minimum desired size, can be recycled along a recycling conveyor 96 shown in FIGS. 3c and 7. The recycling material may be fed back into one or more of the steps or stages described herein above, including but not limited to directly back into the pelletizing drum 34, and/or the sizer 30. FIG. 7 shows a series of conveyors 96 to directly feed recycle pellets and/or unformed material back into the feed conveyor for the pelletizer drum 34.

The process of the present invention may form pellets of any suitable size or diameter. Any material below a certain size or above a certain size may be returned to be re-cycled in the process, so as to achieve a more even pellet size.

Such lower and upper pre-determined limits may be determined by the person skilled in the art based on optional parameters such as the weight or the length of time of material poured thereinto, and/or the intended mixing time.

As shown in FIG. 3c, the pellets 40 are stockpiled for curing. Stockpiling the pellets in a suitable conical arrangement, can be based on including a suitable internal air area or air pocket, such as by the use of suitable pipes 42 or vented pedestals, to allow better circulation of air both within the stockpile, as well as around its outer surface. In this way, the pellets can be dried from two surfaces to speed up the curing process.

The pellets 40 may be stored under a cover 44, such as a shelter or roof, to provide some initial protection from the elements, in particular rain or falling moisture/water, to allow the pellets to achieve an initial green strength to allow further handling and/or more robust stockpiling.

The product preferably allows a very high percentage of combustion (possibly 100% combustion), so as to leave little or no combustible fuel in the ash.

In particular, the process of the present invention can involve no forced drying of the pellets because the action of the polysaccharide or PVOH and cross-linker is maximised in ambient temperatures.

In another embodiment of the present invention, the process of the present invention is carried out by modular apparatus and/or mobile apparatus, able to be relocated to a new location for use with different sources of particulate carbonaceous material.

Optionally, a number of, optionally all, of the processing devices, units or apparatus useable with the present invention are modular and/or mobile, to allow a user to relocate such devices, units or apparatus.

For example, at least the loading or weigh feed hopper 12, the first batch feed conveyor 14, the ball mill 16, the thickening screens 20, the second conveyor 21, the buffering storage or hopper 22, the inclined screw auger 24, the structural platform 28, the pelletiser feed conveyor 32 and the pelletiser unit 34, are all both modular, and optionally mobile, by the use of one or more suitable carriage means such as trailers, wheeled chassis or bogies, and the like, known in the art.

For example, FIG. 2 shows the pelletiser unit 34 having a wheeled carriage at one end, such that the pelletiser unit 34 is moveable to a separate location by use of a suitable unit such as a tractor unit known in the art, by simple towing.

Many conveyors are also intended to be easily relocatable, and FIG. 2 also shows the radial stacking conveyor 36 based on 2-wheeled carriage or chassis, again able to be relocated easily by a suitable towing unit when required in another location.

FIG. 7 also shows each and all of the pelletizer drum 34, grizzly hopper 90 and conveyors 36, 96 on wheels, so as to be easily moveable or mobile, for use in another location when a source of particulate carbonaceous material may be exhausted. Thus, apparatus able to provide the process of the present invention is both modular and mobile.

Thus, according to another embodiment of the present invention, there is provided apparatus for carrying out a process as defined herein, which apparatus is modular and mobile. Such apparatus generally includes the features shown in FIGS. 3c or 7. The skilled man can see that the use of one or more suitable road conveyors such as tractor units, allows the apparatus to be relocatable to any particular location.

In this way, the present invention can be used to pelletise a stock of particulate carbonaceous material at a particular location, and then relocate to the next intended source of particulate carbonaceous material.

One further application of the present process is lowering the feed moisture of pulverised coal fuels in power and heat stations, where the coal fines or coal tailings are pelletised and allowed to thoroughly cure and dry before being pulverised and burnt in the furnace. The general moisture content found in current coal fines dumps is usually in the range 12-35%, making them very difficult to use or blend with other feeds.

The present invention provides a simple but efficient process for using waste carbon-based materials, and forming a useable fuel product, which is easily transportable and efficiently combustible. Rotary drum pelletisers are relatively low cost to build, and are capable of very high tonnage throughputs. Customised products can be produced and the present invention enhances the economics of ash and sulphur removal in coal upgrade plants.

Low technology applications in countries where there is little investment for efficient coal process plants can also easily utilise the present invention, therefore allowing the provision of high efficiency, environmentally friendly and cost effective process plants to be manufactured and operated. In such places, any materials not immediately useable are currently treated as waste and simply stockpiled in bigger and bigger piles, increasing the environmental hazard thereof.

The product of the present invention is ready for use as a fuel in many situations, in particular industrially, such as in a power plant, or a smelter, etc.

The product is formed from currently ‘waste’ materials, thereby increasing the efficiency of current solid-fuel extraction and production.

The present invention provides significant benefits compared with present technologies, including:
<3 mm coal/lignite fines can be pelletised dry or direct from a filtration plant.
Tonnage throughput can be from 5 tonnes per hour (community size) up to 300 or 500 tonnes per hour per pelletising line.
High level of automation can be used during pelletising for accurate control and reagent usage.
Pellets just air dry while chemically ‘curing’.
Pellets can be handled by bulk handling equipment when cured.
Pellet size can be customised from 5 mm to 150 mm if required depending upon coal characteristics and process parameters.
Due to excellent combustion characteristics, high ash coal fines will ignite and burn with high efficiency.
Long lasting combustion, with high percentage carbon combustion.
<20 mm coal can be crushed and pelletised with fines for high value pellets.
Contaminated coal or waste products such as sawdust, rice husks, sewage, animal wastes, petroleum coke or waste oil can be included into the pellets.
Residual ash has negligible un-burnt fuel (e.g. coal) residue and is excellent for other industrial uses.
Residual ash can also be pelletised with similar binder reagents for concrete feedstock, aggregate blending and high porosity landfill.
Lignite can be treated with identical technology or can be blended with other fuel sources to create hybrid pellet fuels with pre-designed characteristics such as smokeless burning.

1. A process for forming a fuel pellet comprising of the following steps:
providing a particulate carbonaceous material having a particle size of <1mm;
admixing the particulate carbonaceous material with a polysaccharide or a polyvinyl alcohol binder, and a crosslinker;
shaping the so-formed mixture to provide the fuel pellet.

2. A process as claimed in claim 1 wherein the process is carried out at ambient or near-ambient temperature.

3. A process as claimed in claim 1 wherein the particulate material is coal dust or coal fines.

4. A process as claimed in claim 1, wherein the shaping includes a post-mixing sizing.

5. A process as claimed in claim 4 wherein the post-mixing sizing comprises the use of a gated hopper or an extrusion hopper.

6. A process as claimed in claim 1, wherein the shaping includes an agglomeration step.

7. A process as claimed in claim 6 wherein the agglomeration step is tumbling agglomeration, or extrusion, or both.

8. A process as claimed in claim 1, wherein the shaping includes a post-pellet forming screening step.

9. A process as claimed in claim 8 wherein the screening step uses a multiscreen hopper having a pre-determined maximum pellet size screen, a predetermined minimum pellet size screen, or both.

10. A process as claimed in claim 1, wherein the admixing comprises pre-blending, kneading-mixing, or both.

11. A process as claimed in claim 1, wherein the binder is one or more of the group comprising;
Carboxymethyl Guar
Acacia Gum
Xanthan Gum
Starches and modified starches
Sodium Alginate
Carboxymethyl cellulose
Hydroxyethyl cellulose
Hydroxyethyl methyl cellulose (Tylose)

12. A process as claimed in any claims claim 1, wherein the crosslinker is a bis-aldehyde, a bis-acid, a carbonate or a borate, containing one or more ions of the group comprising: titanium, sodium, ammonia, zirconium, potassium or calcium.

13. A process as claimed in claim 13 wherein the crosslinker is a zirconium carbonate or sodium borate.

14. A process as claimed in claim 1, comprising providing a particulate carbonaceous material having a particle size of <0.5 mm.

15. A process as claimed claim 1, wherein the particulate carbonaceous material is provided by grinding a feed material to provide a particulate carbonaceous material having a particle size of <1 mm with no more than 10% w/w >1 mm and no less than 5% w/w <38 μm (microns).

16. A process as claimed in claim 15 wherein the grinding is wet grinding, optionally provided by a wet grinding mill or by a wet ball crusher.

17. A process as claimed in claim 1, wherein the particulate carbonaceous material has a water content in the range 18-30 wt %.

18. A process as claimed in claim 1, where the binder is present in the range 0.1 wt % to 2 wt % based on total dry weight of the particulate carbonaceous material, optionally in the range 0.2 wt % to 0.7 wt % based on total dry weight of the particulate carbonaceous material.

19. A process as claimed in claim 1, wherein the crosslinker is present in the range 0.00001 wt % to 0.001 wt % based on dry weight of particulate carbonaceous material.

20. A process as claimed in claim 1 further comprising recycling a portion of the formed fuel pellets.

21. A process as claimed in claim 20 wherein the shaping includes a post-pellet forming screening step, and further comprising recycling a portion of the formed fuel pellets screened out by the screening step.

22. A process as claimed in claim 20 comprising an integrated multi-deck sizing screening step.

23. A process as claimed in claim 1 further comprising the step of stockpiling the fuel pellet under cover for 1-7 days.

24. A process as claimed in claim 1 wherein the process includes at least the steps of:
providing a particulate carbonaceous material having a particle size <1 mm or <0.5 mm and a water content in the range 18-30 wt %;
mixing the so-formed material with the binder and a crosslinker in a pre-blender to form a pelletisable formula;
kneading the pelletisable formula in a mixer to form a mixed material;
sizing the mixed material;
agglomerating the so-formed material to form pellets;
screening and sizing the pellets;
recycling pellets rejected by the screening and sizing back into the agglomeration; and
stockpiling the pellets under cover for 1-7 days.

25. A fuel pellet whenever formed by a process as claimed in claim 1.

26. A fuel pellet as claimed in claim 25 being formed from a coal dust or coal fines.
